(19) United States
(12) Patent Application Publication
(10) Pub. No.: US 2003/0014411 A1
(43) Pub. Date: Jan. 16, 2003

(54) System and method for one-touch e-commerce

(76) Inventor: Rajan Gupta, Montebello, CA (US)

Correspondence Address: RAJAN GUPTA, SUITE 207, 1489 EAST COLORADO BLVD., PASADENA, CA, 91106, US

(21) Appl. No.: 09/906,998

(22) Filed: Jul. 16, 2001

(51) Int. Cl. G06F 7/00

(52) U.S. Cl. 707/9

(57) ABSTRACT

MyWebKey: a data processing system allowing direct connections to specific Internet websites by depressing computer keyboard function keys.

MyWebKey, a customizable data processing system to allow a user to connect to a specific Internet website by depressing a function key on a MyWebKey keyboard, or any standard computer keyboard. The technology can be dynamically configured for use in the B2B market for ordering, and in the B2C market for advertising. The MyWebKey software is distributed to an end-user, who installs it into their computer system's hard drive. The software includes a driver, which is then resident in the system's memory, monitoring whether any function key is pressed by an end-user and activated to provide a direct connection to a website. Whereas an end-user is assigned a Unique User ID and an end-user's system transmits a Unique Keyboard ID, the MyWebKey advertiser/client interface allows an advertiser to determine how many end-users accessed their Internet site. Finally, the process includes a toggle capability, allowing the end-user to change the functionality of their function keys from traditional key operations to one-touch connections to specific Internet websites.

### FIELD OF THE INVENTION

This invention relates generally to data processing systems and, more specifically, to systems and methods for interactive marketing over the Internet.

### BACKGROUND OF THE INVENTION

The Internet functions as a business-to-business and business-to-consumer marketing and advertising tool and is used to facilitate advertising and business transactions in an Internet-enabled economy. For example, the Internet may be used by retailers for both interactive and target marketing techniques. Two of the important strategic considerations in Internet advertising and marketing relate to (1) how a consumer reaches an advertiser's Internet site, and (2) how frequently a consumer reaches an advertiser's Internet site. Advertisers reach target consumers by, for example, sending to a consumer an advertisement email, or advertising on a Internet site that target consumers are likely to view. Consumers may also be prompted to visit a specific Internet site by search engine results, advertisements (e.g., online banners, affiliate link shares, direct email, traditional media—television, radio, billboards, etc.), recall due to strong brand equity and loyalty, and co-branded strategic collaborators possessing brand equity and customer loyalty. Once a consumer has been prompted to enter a Internet site, the consumer may reach the Internet site by, for example, typing in the relevant URL, selecting the URL from a pull-down list of, for example, frequently accessed Internet sites, or favorites (e.g., via a bookmark), selecting, i.e., clicking, on the relevant URL, or via affiliate or partner Internet site. Each of the above methods for an advertiser to reach a consumer, and conversely, for a consumer to reach an advertiser, require the consumer to establish a network connection.

Consumers are likely to visit certain Internet sites more frequently if the overhead associated with reaching the Internet site, e.g., establishing an Internet connection and typing in the URL, is reduced. Similarly, many advertisers may desire to advertise to specific consumers on an ongoing basis, and in an unobtrusive manner. The interaction between advertisers and target consumers is likely to increase given minimal overhead associated with coordinating the parties.

Accordingly, a need exists for a more efficient manner of coordinating advertisers with consumers so that advertisers may conduct target and interactive marketing over the Internet, including both prompting a consumer to visit a Internet site, and reducing the overhead associated with the consumer entering the Internet site.

### SUMMARY OF THE INVENTION

This invention provides a data processing system to allow a user to connect to a specific Internet site by depressing a function key. The system includes a client device connected to a keyboard, a program that receives from a user an indication of a keystroke on the keyboard and initiates execution of a Internet browser included in the client, wherein the Internet browser automatically links the user to a specific Internet site according to which corresponds to the keystroke. A processor executes the program.

This invention also provides a method to allow a user to connect to a specific Internet site by depressing a function key. The method receives from a user a keystroke indicating that a key has been depressed, initiates execution of a Internet browser included in a client device, and links the user to the specific Internet site according to instructions indicating which Internet site is associated with the depressed key. This method further includes redirecting a user to the specific Internet site.

### BRIEF DESCRIPTION OF THE DRAWINGS

FIG. 1 depicts an exemplary network suitable for practicing the present invention;

FIG. 2 depicts a flow diagram of the process to install a keyboard and software suitable for practicing the present invention;

FIG. 3 depicts a flow diagram of the process followed to register an end-user to register the MyWebKey system; and

FIG. 4 depicts a flow diagram of the process performed when an end-user activates a function key activated by the MyWebKey system.

### DETAILED DESCRIPTION OF THE INVENTION

This invention (“MyWebKey”) facilitates business transactions in an Internet-enabled economy and overcomes the shortcomings of the prior art by providing a one-touch e-commerce connection between end-users and advertisers. End-users are typically people who use the Internet. Advertisers are typically entities who want to reach end-users and direct them to their Internet sites. The invention includes a keyboard that has function keys which are programmed and customized to provide one-touch Internet access according to the needs and interests of each end-user. The function keys can include branding logos of an advertiser, allowing the advertiser to advertise to an end-user each time an end-user uses the keyboard. Upon depressing a single function key, an end-user, whether on-line or offline, can be directly connected to a specific Internet site. Further, the present invention includes an advertiser/client interface that allows an advertiser to determine how many end-users accessed their Internet site. More specific information concerning end-users that access an advertiser's Internet site can also be provided to an advertiser.

A part of the present invention is a keyboard that has function keys programmed to connect the end-user to specific Internet sites. The keyboard is distributed to an end-user who connects the keyboard to a computer system. The computer system can include a processor, memory, a Internet browser, and Internet access.

The keyboard of the present invention can include any standard keyboard that includes function keys. A preferred keyboard used as part of the present invention, is a keyboard that has been modified to include icons on the function keys. The icons can include pictures and/or words that inform the end-user of specific Internet sites or topics that can be reached by activating the function keys. For example, an icon for a travel site can be placed on the F2 key. When the F2 key is then pressed, the end-user is directed to a predetermined travel-related Internet site. In this form of the invention, advertisers could place their icon on the keyboard prior to distribution to the end-user. The end-user would then be constantly aware of the advertiser's Internet site while using the keyboard, and the end-user could access the advertiser's Internet site by simply activating the appropriate function key.

Another embodiment of the present invention can allow the end-user to select what Internet sites will be accessed when the function keys are operated. For example, an end-user in the travel industry could program all of the function keys to access a variety of airline sites simply by activating the function keys.

The keyboard can also include a toggle capability. The toggle capability allows for the end-user to change the functionality of the function keys from normal function key operation to one-touch access to specific Internet pages. For example, the “scroll lock” may serve as a toggle key between one-touch Internet access and normal function key operation. This keyboard may be used for both ordering and advertising purposes, streamlining the business process and increasing productivity.

Another part of the present invention is software that causes several actions to occur when the end-user activates a function key that has been toggled to provide one-touch access to an Internet location. Preferably, the software determines if the user has Internet access available. If the user does not have Internet access, the software can attempt to obtain Internet access. For example, the software can attempt to initiate a modem connection by calling an Internet service provider. Once Internet access is obtained, the software causes the end-user's system to transmit various information concerning the end-user and the end-user's selection to a server location. The server, is one or more systems that store information concerning the end-user in a database or databases and redirects the end-user to an Internet location corresponding to the end-user's selection.

Preferably a registration process is used as part of the present invention. In the registration process, the end-user registers the MyWebKey system at a Internet Portal. The Internet Portal can be reached through the end-user's Internet connection. At the Internet Portal, an end-user can register and preferably customize their keyboard. Via this Internet portal, a user may also access additional Internet functions, including, for example, email, chat rooms, calendar, address book, searching, news, weather and other ticker information, facsimile services, broadband service, Internet storage, etc.

The registration process can include having the end-user answer a variety of questions about themselves and their preferences. Preferable questions can include the end-user's: first name, last name, email address, country, home address, home phone number, college attended, college address, employer's name, employer's address, occupation, birth date, gender, race, and spending habits. It will be recognized that these questions represent only a sampling of the possible information that can be collected upon registration. In addition, many of these questions can be emitted to provide the end-user greater privacy. The end-user's responses (hereinafter referred to as UserInfo) to these questions at the Internet Portal are preferably stored in a database on the server system.

Preferably, the user is assigned a unique user identification code (hereinafter referred to as a UserID). Preferably, the UserID is assigned to the end-user during the registration process. The UserID could also be assigned to the MyWebKey system prior to distribution to the end-user. In this embodiment of the invention each individual system is given a UserID before distribution to an end-user. Registering the MyWebKey system then just associates the specific user with the previously determined UserID.

The UserID is linked to the UserInfo. A copy of the UserID can be stored on the end-users computer system in addition to the server system. The UserID is then transmitted to the server when the user activates the MyWebKey software system. By linking the UserID to the UserInfo database, it is possible to access a variety of information about an end-user who is using the MyWebKey system.

In addition to the UserID, the end-user's system preferably transmits a keyboard identification code (hereinafter KeyboardID), which tells the server how the end-user's function keys are programmed. For example, different versions of the software and/or keyboards used as part of the present invention can be distributed to different end-users. For example, on one keyboard, the F2 key may access a sports related Internet site, while on another keyboard the F2 key may access a travel related Internet site. The KeyboardID would allow different versions of the keyboard to be distributed to different end-users, while a single server system is used to redirect the end-user to their selected Internet site.

The end-user's system also preferably transmits which function key is selected by the end-user. The identification of the selected function key along with the KeyboardID, allows the server to determine what Internet site the end-user has chosen. The server can then redirect the end-user according to their selection.

The end-user's system can also transmit a partner identifier. The partner identifier, identifies another party that can be given credit for the end-user's use of the MyWebKey system. This other party, for example, could have distributed the MyWebKey system to the end user or obtained advertisers to advertise on a keyboard used as part of the present invention.

The server receives the information transmitted by the end-user's system via an Internet connection. After receiving this information, the server stores information about the end-user's selection in one or more databases for later use. Preferably the server stores one or more of the following: the UserID, the date and time of the end-user's request, the IP-Address of the end-user, which key the end-user activated, and which Internet site the end-user has chosen. After receiving and storing information about the end-user's request, the server system then redirects the end-user to the Internet address that corresponds to their request.

Another aspect of the present invention is an advertiser/client (hereinafter just referred to as client) information retrieval system. Clients typically own and/or control the Internet locations that the user selects by activating a function key according to the present invention. For example, a client could arrange to have an icon representing their Internet page placed on a keyboard. When an end-user activates the function key with the client's icon on it, the end-user would be transferred by the server system to the client's Internet page. However, clients need not be associated with Internet pages accessed by an end-user activating a function key. Client's can include anyone that seeks to determine information concerning end-user's Internet activities.

By accessing the server, the client could determine specific information about the end-user that access specific Internet pages. Information that can be provided to clients can, for example, include the number of end-users that access a specific page, the average time of day an end-user accesses the specific page, and a geographical breakdown of the IP-Addresses of end-user that access the specific Internet page.

The client may also be given more personal access to information concerning the end-users that access Internet pages using the MyWebKey system. The UserID that is transmitted to the server during the end-user's request, can be linked to the end-user's UserInfo. By linking the UserID with the UserInfo more specific data concerning the end-user's that access the Internet pages can be supplied to the client. For example, the number of end-users that access an Internet page by age group, by gender, and by university attended.

In one embodiment of MyWebKey system, the client is given only non specific information concerning the end-users that access their Internet site. For example, the number of end-users that access their Internet site, a geographical breakdown of the end-users that access their Internet site by IP Address, and the average time of day an end user access's the client's Internet site. In this embodiment of the invention, personal information concerning the end-user is not released to clients or any third parties.

In another embodiment of the MyWebKey system, a client is given access only to information concerning end-users that access Internet pages associated with the particular client. This embodiment of the MyWebKey system maintains the privacy of the clients.

In addition to providing demographic information concerning end-users that access Internet pages using the MyWebKey system, the client information retrieval system can also be used as a way of billing clients. For example, the number of end-users that access a client's Internet page using the MyWebKey system can be calculated. The client could then be charged for each end-user that accesses their Internet page using the MyWebKey system.

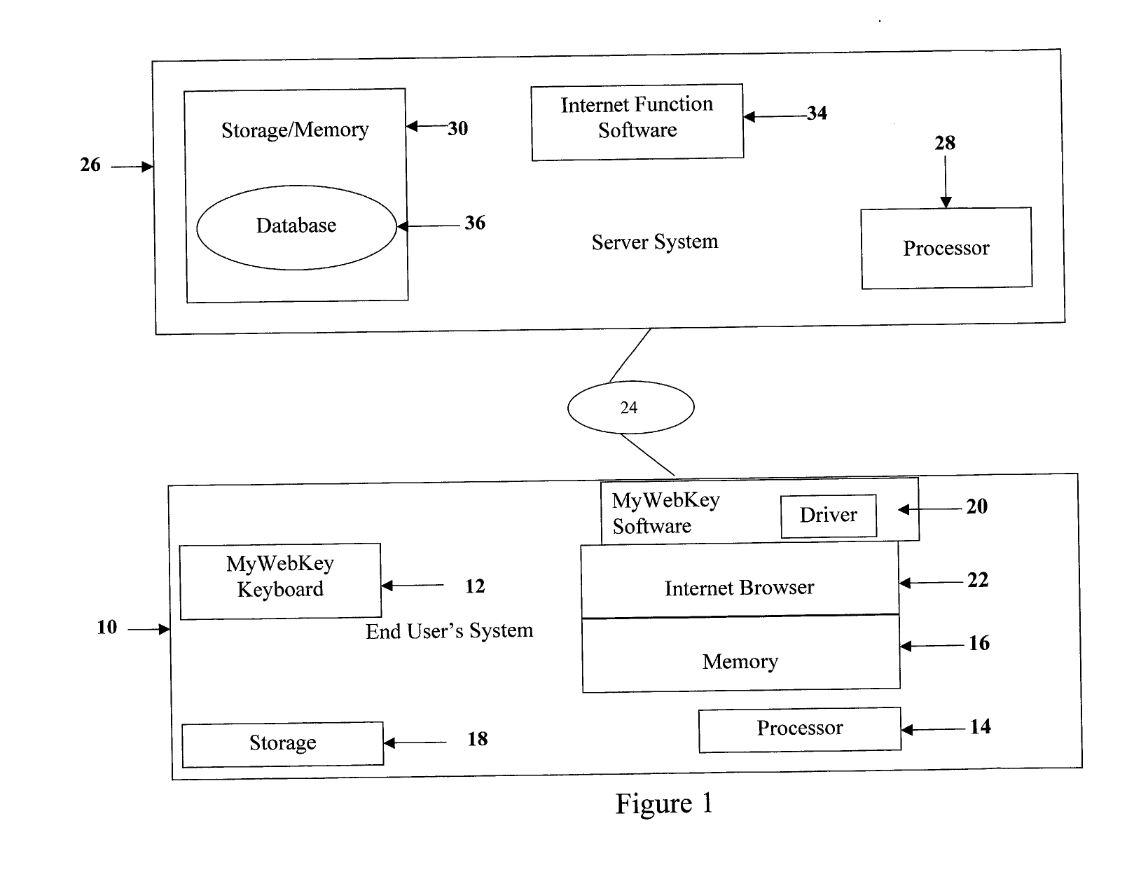

FIG. 1 depicts an exemplary network suitable for practicing the MyWebKey system. The network includes an end-user system 10 and a server system 26 connected by a network 24. The end-users system 10 comprises a MyWebKey keyboard 12, a processor 14, memory 16, storage 18, MyWebKey software 20, and a Internet browser 22. The MyWebKey keyboard 12 includes function keys F1 through F12. The function keys on the MyWebKey keyboard 12 have icons on the function keys that represent Internet sites that an end-user can connect to by activating the appropriate function key. The end-user system can be a conventional PC running a conventional operating system, including, for example, Windows 95, 98, or 2000, or Macintosh. The MyWebKey software 20 includes a driver which is resident in the systems, memory 16. The driver monitors whether any function key that is activated to provide one-touch Internet access is pressed by an end-user.

When an end-user activates an appropriate function key on the MyWebKey keyboard 12, the MyWebKey software 20 is automatically opens a Internet browser program 22 on the end-user system. In addition, the MyWebKey software 20, determines if a network connection 24 has been established. If a network connection 24 has not been established, the MyWebKey software attempts to establish an network connection, by connecting to an internet service provider by modem. If a network connection 24 has been established, the MyWebKey software transfers a UserID and function key selection information to the server system 26 via the internet connection 24.

The server system 26 comprises a processor 28, storage capability 30 which contains a database 36 and Internet function software 34. The database 36 contains previously entered information concerning several end-users. When the server system 26 receives the end-users request over the network 24, the Internet function software 34 causes information concerning the end-user's request to be stored in the database 36. In addition, the Internet function software 34 redirects the end-user's Internet browser 22 to an Internet site corresponding to the activated function key. The end-user activated on the MyWebKey keyboard 12.

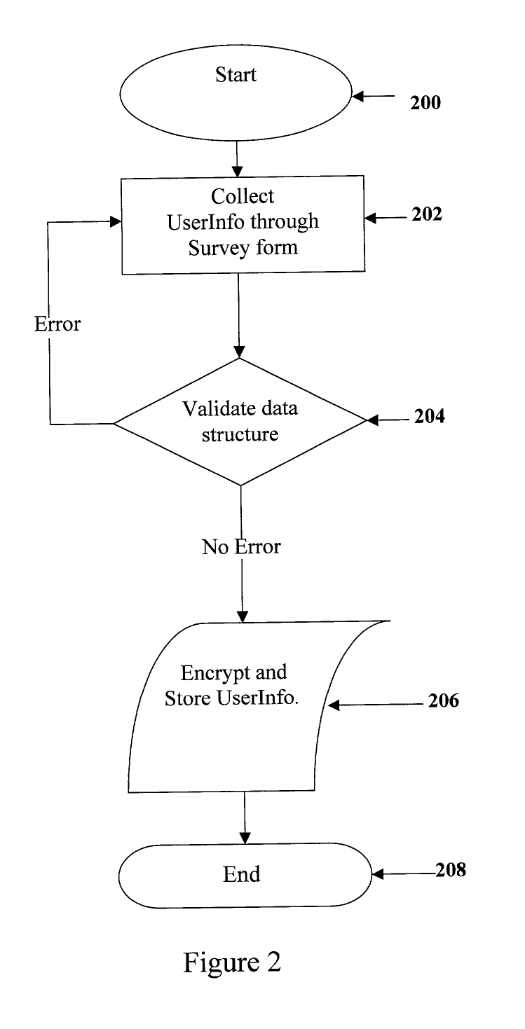

FIG. 2 depicts a software flow diagram of an activation process for activating a MyWebKey keyboard once the MyWebKey keyboard and software have been installed on the end-user's computer. In FIG. 2, the end-user starts by running MyWebKey activation software 202 to activate the keyboard. The activation software first collects UserInfo through a survey form 202. After collecting Userinfo through the survey form, the software then validates that all necessary fields have been filled in 204. If all the necessary fields have not been filled in, or have been filled in incorrectly, the end-user is sent back to step 202 to fill in the missing or incorrect UserInfo. If all necessary fields have been filled in the data is encrypted and stored on the end-user's computer 206. After the Userinfo has been collected, validated, encrypted, and stored on the user's computer, the activation process ends 208.

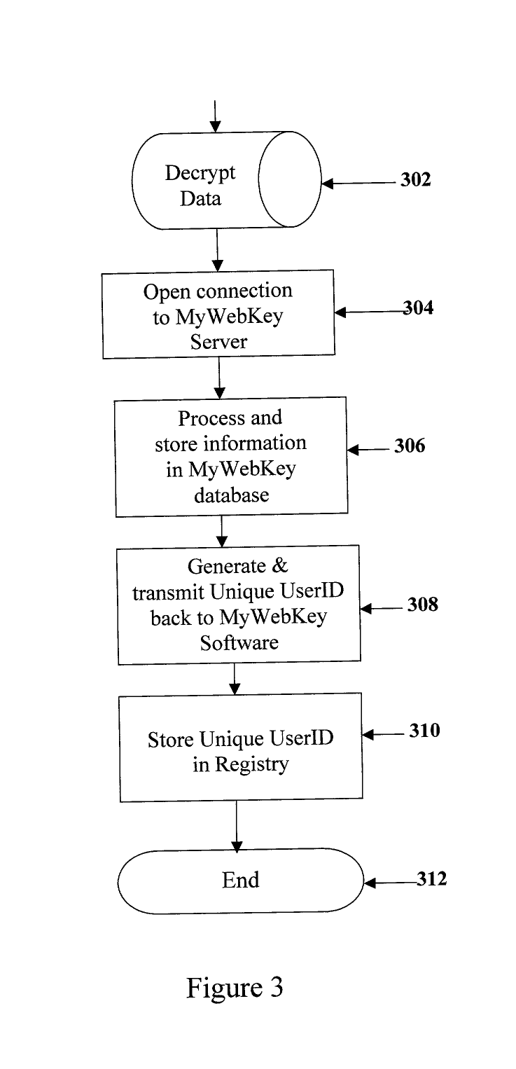

FIG. 3 depicts the procedure for registering the MyWebKey system at the MyWebKey server. The registration process begins by decrypting the UserInfo 302. After the Userinfo is decrypted a connection is established between the end-user's system and the MyWebKey server 304. The MyWebKey server processes and stores the UserInfo in a MyWebKey database 306. The MyWebKey server then generates a unique UserID and transmits the unique UserID back to the end-user's system 308. The unique UserID is stored in the registry of the end-user's system 310. After the unique UserID is stored on the end-user system, the registration process ends 312.

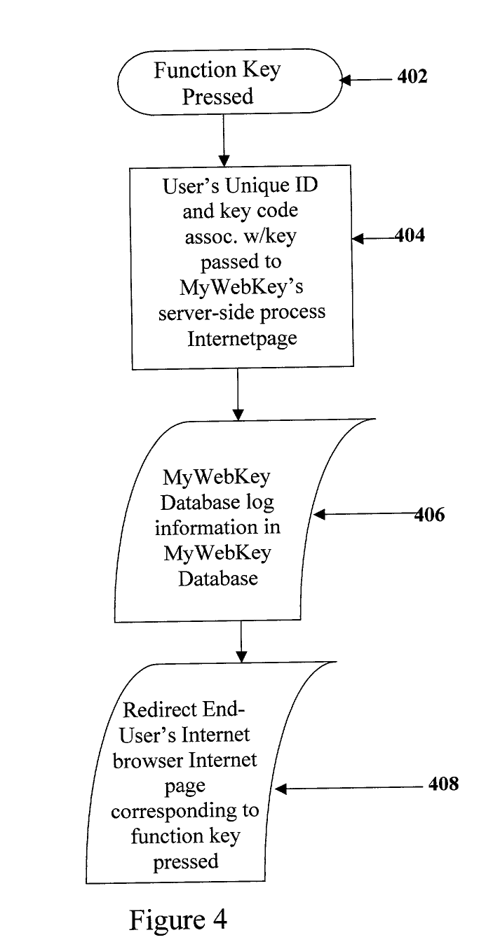

FIG. 4 depicts a process performed when an end-user activates a function activated by the MyWebKey software. The process begins when an end-user presses a function key 402. When an end-user depresses a function key, the end-user's unique UserID and information concerning the configuration of the keyboard and the key depressed by the user is sent to the MyWebKey server 404. The MyWebKey server stores information concerning the user's request in a MyWebKey database 406. The MyWebKey server then redirects the end-user's Internet browser to a Internet page corresponding to the function key activated by the end-user 408.

While the present invention has been described relative to an embodiment, persons of ordinary skill in the art will appreciate that this description is exemplary and that the MyWebKey system may include additional or different components while remaining within the scope of the present invention.

What is claimed is:

1. A method of advertising using the Internet, comprising:
receiving from an end-user a UserID and a selection of a programmed F-key;
storing information concerning the end-user's selection; and
redirecting the user to an Internet location that is associated with the selection.

2. The method of claim 1, wherein the end-user is directed to the Internet location by activating a programmed F-key.

3. The method of claim 1, wherein the programmed F-keys can be toggled between providing access to an Internet location associated with the programmed F-key and normal F-key operation.

4. The method of claim 3, wherein a Scroll Lock key toggles the programmed F-keys.

5. The method of claim 1, wherein a count of the number of redirected users to each Internet location is stored.

6. The method of claim 1, wherein the information concerning the end-user's selection is one or more of the UserID, the date and time of the end-user's request, the IP-Address of the end-user, and the Internet location associated with the end-user's F-key selection.

7. The method of claim 1, wherein personal information concerning the end-user is obtained from the end-user and stored prior to receiving from the end-user a selection of a programmed F-key.

8. The method of claim 7, wherein the personal information concerning the end-user is one or more of the end-user's: name, home address, email address, home phone number, college attended, college address, occupation, employer's name, employer's address, birth date, gender, race, and spending habits.

9. The method of claim 1, further comprising sending information concerning the end-user's selection to a client over the Internet.

10. The method of claim 8, wherein the end-user's personal information is provided to a client over the Internet.

11. The method of claim 1, wherein a partner identifier is received from a user.

12. A data processing system, comprising:
an end-user system that includes a keyboard, wherein the keyboard includes one or more programmed F-keys;
a host system that receives end-user information from the end-user system, and redirects the end-user system to a network location.

13. The data processing system of claim 12, wherein the F-keys have icons representing Internet locations on them.

14. The data processing system of claim 12, wherein the end-user is assigned a unique UserID.

15. The data processing system of claim 12, wherein the end-user information comprises a unique UserID and a selection of a programmed F-key.
